(19) United States
(12) Patent Application Publication
(10) Pub. No.: US 2021/0395575 A1
(43) Pub. Date: Dec. 23, 2021

(54) ADHESIVE AGENT, ADHESIVE TAPE, AND METHOD FOR AFFIXING ELECTRONIC COMPONENTS OR VEHICLE-MOUNTED COMPONENTS

(71) Applicant: SEKISUI CHEMICAL CO., LTD., Osaka (JP)

(72) Inventors: Aya ADACHI, Shiga (JP); Noriyuki UCHIDA, Shiga (JP); Satoshi DOI, Shiga (JP); Yuki IWAI, Osaka (JP)

(73) Assignee: SEKISUI CHEMICAL CO., LTD., Osaka (JP)

(21) Appl. No.: 16/980,684

(22) PCT Filed: May 30, 2019
(86) PCT No.: PCT/JP2019/021534

§ 371 Date: Sep. 14, 2020

(30) Foreign Application Priority Data
Jun. 19, 2018 (JP) 2018-116222

(51) Int. Cl. C09J 7/38; C09J 7/25; C09J 7/26; C09J 11/08; C09J 5/00

(52) U.S. Cl. CPC C09J 7/385; C09J 7/255; C09J 7/26; C09J 11/08; C09J 2203/354; C09J 2433/00; C09J 2467/006; C09J 2493/00; C09J 5/00

(57) ABSTRACT

The present invention aims to provide an adhesive capable of exhibiting excellent adhesive force while having a high bio-derived carbon content, an adhesive tape containing the adhesive, and a method for fixing an electronic device component or an in-vehicle component. Provided is an adhesive containing a (meth)acrylic copolymer that contains 48% by weight or more of structural units derived from a monomer A of a formula (1) containing bio-derived carbon and/or a monomer B of a formula (2) containing bio-derived carbon, and that has a glass transition temperature of −20° C. or lower.

### TECHNICAL FIELD

The present invention relates to an adhesive, an adhesive tape, and a method for fixing an electronic device component or an in-vehicle component.

### BACKGROUND ART

Adhesive tapes containing an adhesive-containing adhesive layer have been widely used to fix components in electronic members, vehicles, houses, and building materials. Specifically, for example, adhesive sheets are used to bond a cover panel for protecting a surface of a portable electronic device to a touch panel module or display panel module, or to bond a touch panel module to a display panel module (see Patent Literatures 1, 2, and 3, for example).

### CITATION LIST

### Patent Literature

### Patent Literature 1: JP 2015-052050 A

### Patent Literature 2: JP 2015-021067 A

### Patent Literature 3: JP 2015-120876 A

### SUMMARY OF INVENTION

### Technical Problem

There have been concerns about the depletion of petroleum resources and carbon dioxide emissions from the combustion of petroleum-derived products. Mainly the medical field and the packaging material field thus have started to conserve petroleum resources by substituting bio-derived materials for petroleum-derived materials. The effort is spreading to various fields, leading to a demand for use of bio-derived materials also in the fields of adhesives and adhesive tapes.

(Meth)acrylic adhesives containing (meth)acrylic copolymers are widely used adhesives having excellent adhesive force. It is possible to use bio-derived materials in (meth)acrylic adhesives. For example, rosin, terpene, or the like can be used as the tackifier. However, achieving excellent adhesive force using many bio-derived materials is difficult.

The present invention aims to provide an adhesive capable of exhibiting excellent adhesive force while having a high bio-derived carbon content, an adhesive tape containing the adhesive, and a method for fixing an electronic device component or an in-vehicle component.

### Solution to Problem

The present invention relates to an adhesive containing a (meth)acrylic copolymer that contains 48% by weight or more of structural units derived from a monomer A of the following formula (1) containing bio-derived carbon and/or a monomer B of the following formula (2) containing bio-derived carbon, and that has a glass transition temperature of −20° C. or lower.

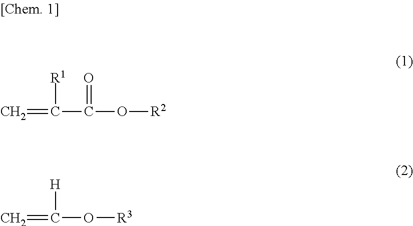

In the formula (1), R¹ is H or CH₃, R² is —CₙH₂ₙ₊₁, and n is an integer of 7 to 14.

In the formula (2), R³ is —C(═O) CₘH₂ₙ₊₁, and m is an integer of 7 to 13.

The carbon in R² and R³ is bio-derived carbon.

The present invention is described in detail below.

The inventors made intensive studies to find out the following: An adhesive capable of exhibiting excellent adhesive force while having a high bio-derived carbon content can be obtained by selecting a monomer A of the formula (1) containing bio-derived carbon (hereinafter also referred to simply as a “monomer A”) and/or a monomer B of the formula (2) containing bio-derived carbon (hereinafter also referred to simply as a “monomer B”) as a raw material of a (meth)acrylic copolymer to constitute the adhesive, and adjusting the glass transition temperature of the (meth)acrylic copolymer to be −20° C. or lower.

The adhesive that is an embodiment of the present invention contains a (meth)acrylic copolymer. Appropriate selection of a raw material monomer allows such a (meth)acrylic adhesive to exhibit excellent adhesive force.

In the present invention, the monomer A and/or the monomer B are/is contained as a raw material monomer of the (meth)acrylic adhesive.

These monomers can be cheaply and easily obtained from, for example, a plant- or animal-sourced saturated fatty acid or unsaturated fatty acid by alcoholization or esterification thereof. Monomers A and B containing plant-derived carbon are origined from resources created with incorporating atmospheric carbon dioxide. Combusting these monomers thus does not increase the total amount of atmospheric carbon dioxide. These monomers form homopolymers having a relatively low glass transition temperature, allowing an adhesive constituted by these monomers to easily exhibit an adhesive function. Thus, using comparatively large amounts of these monomers, optionally in combination with any other non-bio-derived monomer, allows the adhesive to exhibit sufficient adhesive force while increasing the bio-derived carbon content of the entire adhesive.

The alkyl groups contained in R² in the formula (1) and R³ in the formula (2) may be linear or branched. The alkyl groups are preferably linear because such alkyl groups have high cohesive force and can provide higher adhesive force.

Specific examples of the monomer A include n-octyl (meth)acrylate, lauryl (meth)acrylate, n-decyl (meth)acrylate, n-heptyl acrylate, 2-octyl (meth)acrylate, n-nonyl (meth)acrylate, undecyl (meth)acrylate, tetradecyl (meth)acrylate, and myristyl (meth)acrylate. These monomers A may be used alone or in combination of two or more thereof. In particular, the monomer A preferably includes at least one selected from the group consisting of n-octyl (meth)acrylate, lauryl (meth)acrylate, and decyl (meth)acrylate because these monomers are particularly easily available, provide homopolymers having a low glass transition temperature, and allow adhesives constituted by these monomers to easily exhibit an adhesive function. In particular, to obtain an adhesive having excellent shearing force, the monomer A more preferably includes lauryl acrylate and/or lauryl methacrylate, still more preferably lauryl acrylate and lauryl methacrylate.

Specific examples of the monomer B include vinyl caprate, vinyl laurate, vinyl caprylate, and vinyl nonanoate. These monomers B may be used alone or in combination of two or more thereof. The monomer B preferably includes vinyl caprate and/or vinyl laurate because these monomers are particularly easily available, provide homopolymers having a low glass transition temperature, and allow adhesives constituted by these monomers to easily exhibit an adhesive function.

The (meth)acrylic copolymer contains 48% by weight or more of structural units derived from the monomer A and/or the monomer B. This allows the adhesive to exhibit excellent adhesive force while having a high bio-derived carbon content. For higher adhesive force, the (meth)acrylic copolymer contains the structural units derived from the monomer A and/or monomer B more preferably in an amount of 55% by weight or more, still more preferably 65% by weight or more, particularly preferably 75% by weight or more, and usually 100% by weight or less.

When the (meth)acrylic copolymer contains structural units derived from the monomer A, for higher adhesive force, a structural unit derived from lauryl acrylate and/or lauryl methacrylate preferably constitutes 48% by weight or more of the structural units derived from the monomer A.

The amount of the structural unit derived from lauryl acrylate preferably accounts for 10% by weight or more and 90% by weight or less, more preferably 15% by weight or more and 85% by weight or less, still more preferably 19% by weight or more and 77% by weight or less of the total amount of the structural units derived from lauryl acrylate and/or lauryl methacrylate.

The amount of the structural unit derived from lauryl methacrylate preferably accounts for 10% by weight or more and 90% by weight or less, more preferably 15% by weight or more and 85% by weight or less, still more preferably 19% by weight or more and 77% by weight or less of the total amount of the structural units derived from lauryl acrylate and/or lauryl methacrylate.

The (meth)acrylic copolymer may contain a structural unit derived from a different monomer other than the monomer A and monomer B.

The different monomer is not limited. Examples thereof include alkyl (meth)acrylates such as methyl (meth)acrylate, ethyl (meth)acrylate, propyl (meth)acrylate, n-butyl (meth)acrylate, tert-butyl (meth)acrylate, 2-ethylhexyl (meth)acrylate, n-octyl (meth)acrylate, isooctyl (meth)acrylate, n-nonyl (meth)acrylate, isononyl (meth)acrylate, myristyl (meth)acrylate, cetyl (meth)acrylate, stearyl (meth)acrylate, an ester of 5,7,7-trimethyl-2-(1,3,3-trimethylbutyl)octanol-1 and (meth)acrylic acid, an ester of (meth)acrylic acid and an alcohol having one or two methyl groups in a linear main chain and having a total carbon number of 18, behenyl (meth)acrylate, and arachidyl (meth)acrylate.

Examples also include cyclohexyl (meth)acrylate, isobornyl (meth)acrylate, benzyl (meth)acrylate, 2-butoxyethyl (meth)acrylate, 2-phenoxyethyl (meth)acrylate, tetrahydrofurfuryl (meth)acrylate, and polypropylene glycol mono(meth)acrylate.

Furthermore, for example, (meth)acrylates having a hydroxy group, such as 4-hydroxybutyl (meth)acrylate, 2-hydroxyethyl (meth)acrylate, and tetrahydrofurfuryl (meth)acrylate, can be used. For example, monomers having a carboxy group, such as (meth)acrylic acid, can be used. For example, monomers having a glycidyl group, such as glycidyl (meth)acrylate, can be used. For example, monomers having an amide group, such as hydroxyethyl (meth)acrylamide, isopropyl (meth)acrylamide, and dimethylaminopropyl (meth)acrylamide, can be used. Monomers having a nitrile group, such as (meth)acrylonitrile, can be used.

Furthermore, various monomers used in common (meth)acrylic polymers can also be used. Examples thereof include vinyl carboxylates such as vinyl acetate, acrylonitrile, and styrene.

These monomers may be used alone or in combination of two or more thereof.

In particular, to improve adhesiveness to olefin resins such as polypropylene and acrylic resins, the (meth)acrylic copolymer preferably has a structural unit derived from an alkyl (meth)acrylate having a C16-C24 (preferably C18-C23, more preferably C20-C22) alkyl group as the different monomer.

The different monomer preferably contains bio-derived carbon, but may be a non-bio-derived monomer not containing bio-derived carbon. Theoretically, all the raw material monomers of the acrylic copolymer may be monomers containing bio-derived carbon. From the viewpoint of the cost and production efficiency of the adhesive, a comparatively inexpensive, easily available monomer containing bio-derived carbon may be used, and a monomer containing petroleum-derived carbon may be used in combination.

The (meth)acrylic copolymer has a glass transition temperature of −20° C. or lower. This allows the resulting adhesive to exhibit excellent adhesive force. For higher adhesive force, the glass transition temperature of the (meth)acrylic copolymer is preferably −30° C. or lower, still more preferably −40° C. or lower, particularly preferably −50° C. or lower. The glass transition temperature of the (meth)acrylic copolymer is usually −90° C. or higher, preferably −80° C. or higher.

The glass transition temperature of the (meth)acrylic copolymer can be determined by differential scanning calorimetry, for example.

The (meth)acrylic copolymer may have any weight average molecular weight. The lower limit thereof is preferably 300,000 and the upper limit thereof is preferably 2,000,000. When the (meth)acrylic copolymer has a weight average molecular weight within this range, the resulting adhesive can exhibit excellent adhesive force. The lower limit of the weight average molecular weight of the (meth)acrylic copolymer is more preferably 400,000 and the upper limit thereof is more preferably 1,800,000. The lower limit is still more preferably 500,000, particularly preferably 1,000,000.

The weight average molecular weight as used herein means a molecular weight in terms of polystyrene determined by GPC.

The (meth)acrylic copolymer can be obtained by radical reaction of a mixture of the raw material monomers in the presence of a polymerization initiator.

Any radical reaction method may be used. Examples thereof include living radical polymerization and free radical polymerization. Living radical polymerization can produce a copolymer having a more uniform molecular weight and a more uniform composition, reduce the formation of low molecular weight components and the like, and increase the cohesive force of the adhesive layer, compared with free radical polymerization.

The polymerization method is not limited and a conventionally known method may be used. Examples thereof include solution polymerization (boiling point polymerization or constant temperature polymerization), emulsion polymerization, suspension polymerization, and bulk polymerization. Preferred among these is solution polymerization because it allows easy synthesis.

In the case of using solution polymerization as a polymerization method, examples of a reaction solvent include ethyl acetate, toluene, methyl ethyl ketone, methyl sulfoxide, ethanol, acetone, and diethyl ether. These reaction solvents may be used alone or in combination of two or more thereof.

The polymerization initiator is not limited. Examples thereof include organic peroxides and azo compounds. Examples of the organic peroxide include 1,1-bis(t-hexylperoxy)-3,3,5-trimethylcyclohexane, t-hexyl peroxypivalate, t-butyl peroxypivalate, 2,5-dimethyl-2,5-bis(2-ethylhexanoylperoxy)hexane, t-hexyl peroxy-2-ethylhexanoate, t-butyl peroxy-2-ethylhexanoate, t-butyl peroxyisobutyrate, t-butyl peroxy-3,5,5-trimethylhexanoate, and t-butyl peroxylaurate. Examples of the azo compound include azobisisobutyronitrile and azobiscyclohexanecarbonitrile. These polymerization initiators may be used alone or in combination of two or more thereof.

Examples of the polymerization initiator for living radical polymerization include organotellurium polymerization initiators. Any organotellurium polymerization initiator usually used in living radical polymerization may be used. Examples thereof include organotellurium compounds and organotelluride compounds. Here, also in living radical polymerization, an azo compound may be used as a polymerization initiator in addition to the organotellurium polymerization initiator so as to promote the polymerization rate.

The adhesive that is an embodiment of the present invention preferably further contains a cross-linking agent to appropriately adjust the gel fraction.

Any cross-linking agent may be used. Examples thereof include isocyanate cross-linking agents, aziridine cross-linking agents, epoxy cross-linking agents, and metal chelate cross-linking agents.

The adhesive that is an embodiment of the present invention preferably further contains a tackifier to improve adhesiveness to an adherend.

Examples of the tackifier include rosin tackifiers such as rosin resins, rosin ester resins, and hydrogenated rosin resins, terpene tackifiers such as terpene resins and terpene phenol resins, coumarone indene resins, alicyclic saturated hydrocarbon resins, C5 petroleum resins, C9 petroleum resins, and C5-C9 copolymer petroleum resins. These tackifier resins may be used alone or in combination of two or more thereof. Preferred among these are bio-derived rosin tackifiers and bio-derived terpene tackifiers. Examples of bio-derived tackifiers include: rosin resins derived from natural resins such as pine resin; and terpene resins derived from plant essential oils.

When the adhesive layer contains the tackifier, the amount of the tackifier is not limited. The lower limit thereof relative to 100 parts by weight of the (meth)acrylic copolymer is preferably 10 parts by weight and the upper limit thereof is preferably 50 parts by weight. When the amount of the tackifier is within this range, the resulting adhesive can exhibit sufficient adhesive force.

The adhesive that is an embodiment of the present invention may contain an additive such as a silane coupling agent, a plasticizer, an emulsifier, a softener, a filler, a pigment, or a dye, as needed. Also for these additives, bio-derived materials are preferably selected as much as possible.

The adhesive that is an embodiment of the present invention preferably has a bio-derived carbon content of 40% by weight or more. A bio-derived carbon content of 40% by weight or more is an indicator of a “bio-based product”. To reduce environmental load as an adhesive tape, the bio-derived carbon content of the adhesive that is an embodiment of the present invention is more preferably 60% by weight or more, usually 100% by weight or less.

While bio-derived carbon contains a certain proportion of radioisotope (C-14), petroleum-derived carbon hardly contains C-14. Thus, the bio-derived carbon content can be calculated by measuring the C-14 concentration in the adhesive tape. Specifically, the bio-derived carbon content can be measured in conformity with ASTM D6866, a standard widely used in the bioplastics industry.

The present invention also encompasses an adhesive tape including an adhesive layer containing the adhesive.

The adhesive tape that is an embodiment of the present invention may be a non-support tape including no substrate, a one-sided adhesive tape including an adhesive layer on one surface of a substrate, or a double-sided adhesive tape including adhesive layers on both surfaces of a substrate.

The substrate is not limited, and may be a conventionally known substrate. To increase the bio-derived carbon content of the adhesive tape as a whole, a bio-derived substrate is preferably used.

Examples of the bio-derived substrate include films and nonwoven fabrics containing polyesters (PES) such as plant-derived polyethylene terephthalate (PET), polyethylene furanoate (PEF), polylactic acid (PLA), polytrimethylene terephthalate (PTT), polybutylene terephthalate (PBT), and polybutylene succinate (PBS), plant-derived polyethylene (PE), plant-derived polypropylene (PP), plant-derived polyurethane (PU), plant-derived triacetylcellulose (TAC), plant-derived cellulose, and plant-derived polyamide (PA).

From the viewpoint of substrate strength, the substrate is preferably a film containing PES or a film containing PA. From the viewpoint of heat resistance and oil resistance, the substrate is preferably a film containing PA.

Examples of the constituent of the film containing PA include nylon 11, nylon 1010, nylon 610, nylon 510, and nylon 410, which are made from castor oil, and nylon 56, which is made from cellulose.

To use less new petroleum resources and emit less carbon dioxide to reduce environmental load, the substrate may contain recycled resources. The method for recycling resources may involve, for example, collecting waste of packaging containers, home appliance, automobiles, building materials, or food, or waste generated during production process, and subjecting the recovered material to washing, decontamination, or decomposition by heating or fermentation for reuse as a raw material. Examples of the substrate containing recycled resources include films and non-woven fabrics containing PET, PBT, PE, PP, PA, or the like made from resin recycled from collected plastic. The collected waste may be burned to utilize the heat energy in production of the substrate or raw materials thereof. Fats and oils contained in the collected waste may be added to petroleum, and the fractionated or refined products thereof may be used as raw materials.

In another embodiment of the present invention, the substrate may be a foam substrate to improve compression characteristics.

The foam substrate preferably contains PE, PP and/or PU. To achieve both high flexibility and high strength, the foam substrate more preferably contains PE. Examples of the constituent of the foam substrate containing PE include PE made from sugarcane.

The foam substrate may be produced by any method. A preferred method includes preparing a foamable resin composition containing a foaming agent and a PE resin containing PE made from sugarcane, foaming the foaming agent while extruding the foamable resin composition into a sheet using an extruder, and optionally crosslinking the obtained polyolefin foam.

The foam substrate may have any thickness. The lower limit thereof is preferably 50 μm and the upper limit thereof is preferably 300 μm. When the thickness of the foam substrate is within this range, the adhesive tape can exhibit high shock resistance while exhibiting high flexibility that allows a close fit to the shape of an adherend in bonding.

The lower limit of the gel fraction of the adhesive layer is preferably 10% by weight, more preferably 20% by weight and the upper limit thereof is preferably 70% by weight, more preferably 50% by weight. When the gel fraction is within this range, the resulting adhesive tape can exhibit sufficient adhesive force.

The gel fraction is measured as follows. The adhesive tape is cut to a 50 mm×100 mm flat rectangular shape to prepare a specimen. The specimen is immersed in ethyl acetate at 23° C. for 24 hours, then taken out of the ethyl acetate, and dried at 110° C. for 1 hour. The weight of the specimen after drying is measured, and the gel fraction is calculated by the following equation. The specimen includes no release film for protecting the adhesive layer.

Gel fraction (% by weight)=100×(W2−W0)/(W1−W0)

(W0: the weight of the substrate, W1: the weight of specimen before immersion, W2: the weight of the specimen after immersion and drying)

The adhesive layer may have any thickness. The lower limit thereof is preferably 10 μm and the upper limit thereof is preferably 100 μm. When the thickness of the adhesive layer is within this range, the resulting adhesive tape can exhibit sufficient adhesive force.

The lower limit of the total thickness of the adhesive tape that is an embodiment of the present invention (the total thickness of the substrate and the adhesive layer) is preferably 10 μm and the upper limit is preferably 400 μm. When the total thickness of the adhesive tape is within this range, the resulting adhesive tape can exhibit sufficient adhesive force.

The adhesive tape that is an embodiment of the present invention may be produced by any method, and may be produced by a conventionally known production method. For example, a double-sided adhesive tape may be produced by the following method.

First, a solvent is added to the (meth)acrylic copolymer and optionally a crosslinking agent, a tackifier, and the like, thereby preparing a solution of an adhesive A. The solution of an adhesive A is applied to a surface of the substrate, and the solvent in the solution is completely removed by drying to form an adhesive layer A. Next, a release film is placed on the adhesive layer A such that the release-treated surface of the release film faces the adhesive layer A.

Then, another release film is provided and to the release-treated surface of the release film is applied a solution of an adhesive B. The solvent in the solution is completely removed by drying. Thus, a laminated film including an adhesive layer B formed on a surface of the release film is produced. The obtained laminated film is placed on the rear surface of the substrate on which the adhesive layer A is formed, such that the adhesive layer B faces the rear surface of the substrate. Thus, a laminate is produced. The laminate is pressurized using a rubber roller or the like to provide a double-sided adhesive tape including adhesive layers on both surfaces of the substrate, in which the surface of each adhesive layer is covered with a release film.

In another method, two laminated films are produced in the same manner as above. The laminated films are placed on both surfaces of the substrate in such a manner that the adhesive layer of each laminated film faces the substrate, thereby preparing a laminate. The laminate is pressurized using a rubber roller or the like to provide a double-sided adhesive tape including adhesive layers on both surface of the substrate, in which the surface of each adhesive layer is covered with a release film.

The adhesive tape that is an embodiment of the present invention may be used in any application. Since it has excellent adhesive force and excellent heat resistance, it can be particularly suitably used for fixing an electronic device component or an in-vehicle component. Specifically, the adhesive tape that is an embodiment of the present invention can be suitably used for bonding and fixing of an electronic device component in a large portable electronic device and bonding and fixing of an in-vehicle component (e.g., in-vehicle panel).

Another embodiment of the present invention provides a method for fixing an electronic device component or an in-vehicle component using the adhesive tape. This method enables not only firm fixing of an electronic device component or an in-vehicle component, but also persistent fixing even at high temperature.

### Advantageous Effects of Invention

The present invention can provide an adhesive capable of exhibiting excellent adhesive force while having a high bio-derived carbon content, an adhesive tape containing the adhesive, and a method for fixing an electronic device component or an in-vehicle component.

### DESCRIPTION OF EMBODIMENTS

The embodiments of the present invention are more specifically described in the following with reference to examples. These examples are not intended to limit the present invention.

### <Monomer A>

### (1) Preparation of Lauryl Acrylate Containing Bio-Derived Carbon

Lauryl acrylate was prepared by esterifying acrylic acid with lauryl alcohol. The lauryl alcohol was prepared by hydrolyzing fat and oil contained in palm kernel oil, coconut oil, and the like, fractionating the resulting fatty acid to recover lauric acid, and hydrogen-reducing the lauric acid.

(2) Preparation of lauryl methacrylate containing bio-derived carbon

Lauryl methacrylate was prepared by esterifying methacrylic acid with lauryl alcohol obtained by the above method.

(3) Preparation of n-Decyl Methacrylate Containing Bio-Derived Carbon

n-Decyl methacrylate was prepared by esterifying methacrylic acid with n-decyl alcohol. The n-decyl alcohol was prepared by hydrolyzing fat and oil contained in palm kernel oil, coconut oil, and the like, fractionating the resulting fatty acid to recover capric acid, and hydrogen-reducing the capric acid.

(4) Preparation of n-Octyl Acrylate Containing Bio-Derived Carbon

n-Octyl acrylate was prepared by esterifying acrylic acid with n-octyl alcohol. The n-octyl alcohol was prepared by hydrolyzing fat and oil contained in palm kernel oil, coconut oil, and the like, fractionating the resulting fatty acid to recover caplyric acid, and hydrogen-reducing the caplyric acid.

### (5) Preparation of Isobornyl Acrylate Containing Bio-Derived Carbon

Isobornyl acrylate was prepared by reacting acrylic acid and camphene. The acrylic acid and camphene were reacted by a method disclosed in JP 2006-69944 A. The camphene was obtained by isomerizing α-pinene obtained from pine resin or turpentine.

### <Monomer B>

### (1) Preparation of Vinyl Laurate Containing Bio-Derived Carbon

Vinyl laurate was prepared by hydrolyzing fat and oil contained in palm kernel oil, coconut oil, and the like, fractionating the resulting fatty acid to recover lauric acid, and vinylating the lauric acid.

### (2) Preparation of Vinyl Caprate Containing Bio-Derived Carbon

Vinyl caprate was prepared by hydrolyzing fat and oil contained in palm kernel oil, coconut oil, and the like, fractionating the resulting fatty acid to recover capric acid, and vinylating the capric acid.

<Monomer Containing Bio-Derived Carbon Other than Monomer a and Monomer B>

Stearyl acrylate was prepared by esterifying acrylic acid with stearyl alcohol. Stearyl alcohol was prepared by hydrolyzing fat and oil contained in palm oil, palm kernel oil, soybean oil, rapeseed oil, and the like, fractionating the resulting fatty acid to recover stearic acid, and hydrogen-reducing the stearic acid.

### <Non-Bio-Derived Monomer>

The following commercial monomers were provided as non-bio-derived monomers.

(1) 2-ethylhexyl acrylate (produced by Mitsubishi Chemical Corporation, glass transition temperature: −70° C.)
(2) butyl acrylate (produced by Mitsubishi Chemical Corporation, glass transition temperature: −55° C.)
(3) ethyl acrylate (produced by Mitsubishi Chemical Corporation, glass transition temperature: −20° C.)
(4) methyl acrylate (produced by Mitsubishi Chemical Corporation, glass transition temperature: −8° C.)
(5) acrylic acid (produced by Nippon Shokubai Co., Ltd. glass transition temperature: 106° C.)
(6) hydroxyethyl acrylate (produced by Osaka Organic Chemical Industry Ltd., glass transition temperature: −15° C.)

### <Cross-Linking Agent>

A commercial polyisocyanate cross-linking agent (produced by Tosoh Corporation, Coronate L-45) was provided as a cross-linking agent.

### <Tackifier>

The following commercial tackifiers containing bio-derived carbon were provided as tackifiers.

(1) terpene phenol resin A (produced by Yasuhara Chemical Co., Ltd., G150, softening point: 150° C., bio-derived carbon content: 67% by weight)
(2) polymerized rosin ester resin B (hydroxy value: 46, softening point: 152° C., bio-derived carbon content: 95% by weight)
(3) hydrogenated rosin ester resin C (produced by Arakawa Chemical Industries Ltd., KE359, hydroxy value: 40, softening point: 100° C., bio-derived carbon content: 95% by weight)

### Example 1

### (1) Preparation of (Meth)Acrylic Copolymer

A reaction vessel was charged with ethyl acetate as a polymerization solvent and the ethyl acetate was bubbled with nitrogen. The reaction vessel was heated while nitrogen was flowed thereinto, thereby starting reflux. Subsequently, to the reaction vessel was added a polymerization initiator solution prepared by 10 times dilution of 0.1 parts by weight of azobisisobutyronitrile as a polymerization initiator in ethyl acetate. Then, 34 parts by weight of the lauryl acrylate, 48 parts by weight of the n-octyl acrylate, 14 parts by weight of the ethyl acrylate, 3 parts by weight of the acrylic acid, and 0.5 parts by weight of the hydroxyethyl acrylate were added dropwise over two hours. After the dropwise addition, the polymerization initiator solution prepared by 10 times dilution of 0.1 parts by weight of azobisisobutyronitrile as a polymerization initiator in ethyl acetate was added again to the reaction vessel, and the polymerization reaction was allowed to proceed for four hours. Thus, a (meth)acrylic copolymer-containing solution was obtained.

The glass transition temperature of the obtained (meth)acrylic copolymer was measured using a differential scanning calorimeter (DSC6220, produced by Seiko Instruments Inc). The glass transition temperature was −44° C.

The obtained (meth)acrylic copolymer was diluted 50 times in tetrahydrofuran (THF). The obtained dilution was filtered through a filter (material: polytetrafluoroethylene, pore size: 0.2 μm), whereby a measurement sample was prepared. This measurement sample was fed into a gel permeation chromatograph (produced by Waters Corporation, 2690 Separations Model) and analyzed by GPC at a sample flow rate of 1 mL/min and a column temperature of 40° C. to measure the molecular weight of the (meth)acrylic copolymer in terms of polystyrene. Thus, the weight average molecular weight was determined. The weight average molecular weight was 720,000.

### (2) Production of Adhesive Tape

To the obtained (meth)acrylic copolymer-containing solution were added 3 parts by weight of the cross-linking agent, 10 parts by weight of the terpenephenolic resin A, 14 parts by weight of the polymerized rosin ester resin B, and 10 parts by weight of the hydrogenated rosin ester resin C relative to 100 parts by weight of the (meth)acrylic copolymer, whereby an adhesive solution was prepared. The adhesive solution was applied to a release-treated PET film having a thickness of 75 μm such that the adhesive layer after drying would have a thickness of 50 μm, and then dried at 110° C. for five minutes. This adhesive layer was placed on a release-treated PET film having a thickness of 75 μm and aged at 40° C. for 48 hours, whereby an adhesive tape (non-support type) was obtained.

The release film on one surface of the obtained adhesive tape was removed. The adhesive tape was attached to a PET film having a thickness of 50 μm and cut to a 20 mm×40 mm flat rectangular shape. The release film of the other surface of the adhesive tape was removed, whereby a specimen was prepared. The weight of the specimen was measured. The specimen was immersed in ethyl acetate at 23° C. for 24 hours, taken out of the ethyl acetate, and dried at 110° C. for 1 hour. The weight of the specimen after drying was measured, and the gel fraction was calculated by the following equation. The gel fraction was 38% by weight.

Gel fraction (% by weight)=100×(W₅−W₃)/(W₄−W₃)

(W₃: the weight of the PET film, W₄: the weight of the specimen before ethyl acetate immersion, W₅: the weight of the specimen after ethyl acetate immersion and drying)

### Examples 2 to 28 and Comparative Examples 1 to 5

Adhesive tapes were obtained as in Example 1 except that monomers of the (meth)acrylic copolymer and tackifiers compounded into the adhesive tapes were as shown in Tables 1 to 4.

In Example 21, a double-sided adhesive tape was produced. The double-sided adhesive tape had adhesive layers (each having a thickness of 25 μm) on both surfaces of a substrate. The substrate used was a film having a thickness of 25 μm formed from nylon 610 (produced by Toray Industries Inc., CM2001), a plant-derived polyamide resin.

In Example 22, a double-sided adhesive tape was produced by the method below. The double-sided adhesive tape had adhesive layers (each having a thickness of 50 μm) on both surfaces of a foam substrate.

The adhesive solution was applied to a release-treated PET film having a thickness of 75 μm such that the adhesive layer after drying would have a thickness of 50 μm, and then dried at 110° C. for five minutes to give an adhesive layer A. The adhesive layer A was placed on a PE foam substrate having a thickness of 100 μm and an expansion ratio of 3 times and pressurized with a rubber roller or the like, whereby a laminate was prepared that had the adhesive layer A on a surface of the release film. Next, another release film was provided, to which the adhesive solution was applied such that the adhesive layer after drying would have a thickness of 50 μm. The applied solution was then dried at 110° C. for five minutes to give an adhesive layer B. The adhesive layer B was attached to the surface of the foam substrate of the laminate opposite to the adhesive layer A. The adhesive layer B was similarly pressurized with a rubber roller or the like and aged at 40° C. for 48 hours, whereby a double-sided adhesive tape was obtained that had adhesive layers on both surfaces of a foam substrate.

### (Evaluation)

The adhesive tapes obtained in the examples and comparative examples were evaluated as follows.

Tables 1 to 4 show the results.

### (1) Bio-Derived Carbon Content

The bio-derived carbon content of the obtained adhesive tape was measured in conformity with ASTM D6866.

### (2) Measurement of Plane Direction Peeling Force

A 10 mm wide×10 mm double-sided adhesive tape was interposed between two SUS plates, bonded to the plates by pressure bonding for 10 seconds using a 5-kg weight, and then aged at 23° C. and a humidity of 50% for 24 hours. The resulting laminate was placed on a fixture, with the two SUS plates being horizontal. The lower SUS plate was fixed, and the upper SUS plate was pulled in the perpendicular direction at a pulling speed of 10 mm/min to determine the force (N) at which the tape was peeled. The plane direction peeling force (Pa) was determined by the following calculation.

Plane direction peeling force (Pa)=force (N) at which tape is peeled/tape area (m²)

The adhesive tape of Example 22 had a very high plane direction peeling force. The foam substrate broke when a load exceeded 0.8 MPa.

### (3) Measurement of Shear Direction Peeling Force

A 10 mm wide×10 mm double-sided adhesive tape was interposed between two SUS plates, bonded to the plates by pressure bonding for 10 seconds using a 5-kg weight, and then aged at 23° C. and a humidity of 50% for 24 hours. The resulting laminate was placed on a fixture, with the two SUS plates being vertical. One of the SUS plates was fixed with the lower holder, and the other SUS plate was fixed with the upper holder. The upper holder was then pulled in the perpendicular direction at a pulling speed of 10 mm/min to determine the force (N) at which the tape was peeled. The shear direction peeling force (Pa) was determined by the following calculation.

Shear direction peeling force (Pa)=force (N) at which tape is peeled/tape area (m²)

The adhesive tape of Example 22 had a very high shear direction peeling force. The foam substrate broke when a load exceeded 0.8 MPa.

TABLE 1

| | | | Example | | | | | |
|---|---|---|---|---|---|---|---|---|
| | | | 1 | 2 | 3 | 4 | 5 | 6 |
| (Meth)acrylic | Monomer A | Lauryl acrylate | 34 | — | 48 | 48 | 34 | — |
| copolymer | | Lauryl methacrylate | — | 34 | — | — | 34 | 97 |
| | | n-Decyl methacrylate | — | — | — | — | — | — |
| | | n-Octyl acrylate | 48 | 48 | — | — | — | — |
| | | n-Heptyl acrylate | — | — | — | — | — | — |
| | | Isobornyl acrylate | — | — | — | — | — | — |
| | Monomer B | Vinyl laurate | — | — | — | 19 | — | — |
| | | Vinyl caprate | — | — | — | — | — | — |
| | Bio-derived | Stearyl acrylate | — | — | — | — | — | — |
| | monomer | Isostearyl acrylate | — | — | — | — | — | — |
| | | 2-Decyl tetradecanyl | — | — | — | — | — | — |
| | | acrylate | | | | | | |
| | Non-bio-derived | 2-Ethylhexyl acrylate | — | — | 48 | — | 29 | — |
| | monomer | Butyl acrylate | — | — | — | 29 | — | — |
| | | Ethyl acrylate | 14 | — | — | — | — | — |
| | | Methyl acrylate | — | 14 | — | — | — | — |
| | | Acrylic acid | 3 | 3 | 3 | 3 | 3 | 3 |
| | | Hydroxyethyl acrylate | 0.5 | 0.5 | 0.5 | 0.5 | 0.5 | 0.5 |
| | Glass transition temperature (° C.) | | −44 | −51 | −52 | −51 | −46 | −39 |
| | Weight average molecular weight (×10⁴) | | 72 | 65 | 78 | 62 | 71 | 59 |
| Cross-linking agent (parts by weight) | | | 3 | 3 | 2 | 3 | 3 | 3 |
| Tackifier | | Terpene phenol resin A | 10 | 10 | 10 | 10 | 10 | 10 |
| (parts by weight) | | Polymerized rosin ester resin B | 14 | 14 | 14 | 14 | 14 | 14 |
| | | Hydrogenated rosin ester resin C | 10 | 10 | 10 | 10 | 10 | 10 |
| Thickness of adhesive tape (μm) | | | 50 | 50 | 50 | 50 | 50 | 50 |
| Gel fraction of adhesive tape (% by weight) | | | 38 | 41 | 39 | 42 | 34 | 34 |
| Thickness of substrate (μm) (nylon 610) | | | — | — | — | — | — | — |
| Thickness of substrate (μm) | | | — | — | — | — | — | — |
| (foam substrate, expansion ratio 3 times) | | | | | | | | |
| Evaluation | Bio-derived carbon | % by weight | 71 | 70 | 52 | 67 | 62 | 77 |
| | content | | | | | | | |
| | Plane direction | MPa | 0.97 | 0.94 | 0.91 | 0.96 | 1.05 | 0.98 |
| | peeling force | | | | | | | |
| | Shear direction | MPa | 1.12 | 1.25 | 0.90 | 0.93 | 1.27 | 1.95 |
| | peeling force | | | | | | | |

| | | | Example | | | |
|---|---|---|---|---|---|---|
| | | | 7 | 8 | 9 | 10 |
| (Meth)acrylic | Monomer A | Lauryl acrylate | 19 | 48 | 48 | 48 |
| copolymer | | Lauryl methacrylate | 77 | 48 | 48 | 48 |
| | | n-Decyl methacrylate | — | — | — | — |
| | | n-Octyl acrylate | — | — | — | — |
| | | n-Heptyl acrylate | — | — | — | — |
| | | Isobornyl acrylate | — | — | — | — |
| | Monomer B | Vinyl laurate | — | — | — | — |
| | | Vinyl caprate | — | — | — | — |
| | Bio-derived | Stearyl acrylate | — | — | — | — |
| | monomer | Isostearyl acrylate | — | — | — | — |
| | | 2-Decyl tetradecanyl | — | — | — | — |
| | | acrylate | | | | |
| | Non-bio-derived | 2-Ethylhexyl acrylate | — | — | — | — |
| | monomer | Butyl acrylate | — | — | — | — |
| | | Ethyl acrylate | — | — | — | — |
| | | Methyl acrylate | — | — | — | — |
| | | Acrylic acid | 3 | 3 | 3 | 3 |
| | | Hydroxyethyl acrylate | 0.5 | 0.5 | 0.5 | 0.5 |
| | Glass transition temperature (° C.) | | −33 | −27 | −27 | −27 |
| | Weight average molecular weight (×10⁴) | | 62 | 57 | 57 | 57 |
| Cross-linking agent (parts by weight) | | | 3 | 1 | 1.5 | 3 |
| Tackifier | | Terpene phenol resin A | 10 | 0 | 0 | 10 |
| (parts by weight) | | Polymerized rosin ester resin B | 14 | 0 | 5 | 14 |
| | | Hydrogenated rosin ester resin C | 10 | 0 | 5 | 10 |
| Thickness of adhesive tape (μm) | | | 50 | 50 | 50 | 50 |
| Gel fraction of adhesive tape (% by weight) | | | 33 | 31 | 29 | 27 |
| Thickness of substrate (μm) (nylon 610) | | | — | — | — | — |
| Thickness of substrate (μm) | | | — | — | — | — |
| (foam substrate, expansion ratio 3 times) | | | | | | |
| Evaluation | Bio-derived carbon | % by weight | 78 | 76 | 78 | 79 |
| | content | | | | | |
| | Plane direction | MPa | 1.07 | 0.81 | 1.04 | 1.28 |
| | peeling force | | | | | |
| | Shear direction | MPa | 1.35 | 0.85 | 0.92 | 1.41 |
| | peeling force | | | | | |

TABLE 2

| | | | Example | | | | | |
|---|---|---|---|---|---|---|---|---|
| | | | 11 | 12 | 13 | 14 | 15 | 16 |
| (Meth)acrylic | Monomer A | Lauryl acrylate | 48 | 77 | — | — | — | — |
| copolymer | | Lauryl methacrylate | 48 | 19 | — | — | — | — |
| | | n-Decyl methacrylate | — | — | 48 | — | — | — |
| | | n-Octyl acrylate | — | — | — | 48 | 68 | 97 |
| | | n-Heptyl acrylate | — | — | — | — | — | — |
| | | Isobornyl acrylate | — | — | — | — | — | — |
| | Monomer B | Vinyl laurate | — | — | — | — | — | — |
| | | Vinyl caprate | — | — | — | — | — | — |
| | Bio-derived | Stearyl acrylate | — | — | — | — | — | — |
| | monomer | Isostearyl acrylate | — | — | — | — | — | — |
| | | 2-Decyl tetradecanyl | — | — | — | — | — | — |
| | | acrylate | | | | | | |
| | Non-bio-derived | 2-Ethylhexyl acrylate | — | — | 48 | 48 | 29 | — |
| | monomer | Butyl acrylate | — | — | — | — | — | — |
| | | Ethyl acrylate | — | — | — | — | — | — |
| | | Methyl acrylate | — | — | — | — | — | — |
| | | Acrylic acid | 3 | 3 | 3 | 3 | 3 | 3 |
| | | Hydroxyethyl acrylate | 0.5 | 0.5 | 0.5 | 0.5 | 0.5 | 0.5 |
| | Glass transition temperature (° C.) | | −27 | −23 | −76 | −75 | −75 | −73 |
| | Weight average molecular weight (×10⁴) | | 57 | 63 | 73 | 77 | 72 | 69 |
| Cross-linking agent (parts by weight) | | | 3.5 | 3 | 2 | 1 | 1 | 0.5 |
| Tackifier | | Terpene phenol resin A | 15 | 10 | 10 | 10 | 10 | 0 |
| (parts by weight) | | Polymerized rosin ester resin B | 20 | 14 | 14 | 14 | 14 | 0 |
| | | Hydrogenated rosin ester resin C | 15 | 10 | 10 | 10 | 10 | 0 |
| Thickness of adhesive tape (μm) | | | 50 | 50 | 50 | 50 | 50 | 50 |
| Gel fraction of adhesive tape (% by weight) | | | 31 | 35 | 31 | 34 | 33 | 35 |
| Thickness of substrate (μm) (nylon 610) | | | — | — | — | — | — | — |
| Thickness of substrate (μm) | | | — | — | — | — | — | — |
| (foam substrate, expansion ratio 3 times) | | | | | | | | |
| Evaluation | Bio-derived carbon | % by weight | 80 | 80 | 50 | 49 | 60 | 71 |
| | content | | | | | | | |
| | Plane direction | MPa | 1.09 | 1.09 | 0.85 | 0.87 | 0.93 | 0.82 |
| | peeling force | | | | | | | |
| | Shear direction | MPa | 1.19 | 0.81 | 0.90 | 0.97 | 0.94 | 0.87 |
| | peeling force | | | | | | | |

| | | | Example | | | |
|---|---|---|---|---|---|---|
| | | | 17 | 18 | 19 | 20 |
| (Meth)acrylic | Monomer A | Lauryl acrylate | — | — | — | — |
| copolymer | | Lauryl methacrylate | — | — | — | — |
| | | n-Decyl methacrylate | — | — | — | — |
| | | n-Octyl acrylate | 97 | — | 48 | 48 |
| | | n-Heptyl acrylate | — | 97 | — | — |
| | | Isobornyl acrylate | — | — | 19 | — |
| | Monomer B | Vinyl laurate | — | — | — | — |
| | | Vinyl caprate | — | — | — | 19 |
| | Bio-derived | Stearyl acrylate | — | — | — | — |
| | monomer | Isostearyl acrylate | — | — | — | — |
| | | 2-Decyl tetradecanyl | — | — | — | — |
| | | acrylate | | | | |
| | Non-bio-derived | 2-Ethylhexyl acrylate | — | — | — | — |
| | monomer | Butyl acrylate | — | — | 29 | 29 |
| | | Ethyl acrylate | — | — | — | — |
| | | Methyl acrylate | — | — | — | — |
| | | Acrylic acid | 3 | 3 | 3 | 3 |
| | | Hydroxyethyl acrylate | 0.5 | 0.5 | 0.5 | 0.5 |
| | Glass transition temperature (° C.) | | −73 | −31 | −47 | −67 |
| | Weight average molecular weight (×10⁴) | | 69 | 63 | 79 | 74 |
| Cross-linking agent (parts by weight) | | | 1 | 1.7 | 3 | 3 |
| Tackifier | | Terpene phenol resin A | 10 | 10 | 10 | 10 |
| (parts by weight) | | Polymerized rosin ester resin B | 14 | 14 | 14 | 14 |
| | | Hydrogenated rosin ester resin C | 10 | 10 | 10 | 10 |
| Thickness of adhesive tape (μm) | | | 50 | 50 | 50 | 50 |
| Gel fraction of adhesive tape (% by weight) | | | 35 | 51 | 41 | 38 |
| Thickness of substrate (μm) (nylon 610) | | | — | — | — | — |
| Thickness of substrate (μm) | | | — | — | — | — |
| (foam substrate, expansion ratio 3 times) | | | | | | |
| Evaluation | Bio-derived carbon | % by weight | 75 | 73 | 61 | 62 |
| | content | | | | | |
| | Plane direction | MPa | 0.96 | 1.13 | 0.88 | 0.89 |
| | peeling force | | | | | |
| | Shear direction | MPa | 0.98 | 0.81 | 1.01 | 0.85 |
| | peeling force | | | | | |

TABLE 3

| | | | Example | | | | |
|---|---|---|---|---|---|---|---|
| | | | 21 | 22 | 23 | 24 | 25 |
| (Meth)acrylic | Monomer A | Lauryl acrylate | 48 | 48 | 77 | — | 34 |
| copolymer | | Lauryl methacrylate | 48 | 48 | — | 77 | 34 |
| | | n-Decyl methacrylate | — | — | — | — | — |
| | | n-Octyl acrylate | — | — | — | — | — |
| | | n-Heptyl acrylate | — | — | — | — | — |
| | | Isobornyl acrylate | — | — | — | — | — |
| | Monomer B | Vinyl laurate | — | — | — | — | — |
| | | Vinyl caprate | — | — | — | — | — |
| | Bio-derived | Stearyl acrylate | — | — | — | — | — |
| | monomer | Isostearyl acrylate | — | — | — | — | — |
| | | 2-Decyl tetradecanyl | — | — | 19 | 19 | 29 |
| | | acrylate | | | | | |
| | Non-bio-derived | 2-Ethylhexyl acrylate | — | — | — | — | — |
| | monomer | Butyl acrylate | — | — | — | — | — |
| | | Ethyl acrylate | — | — | — | — | — |
| | | Methyl acrylate | — | — | — | — | — |
| | | Acrylic acid | 3 | 3 | 3 | 3 | 3 |
| | | Hydroxyethyl acrylate | 0.5 | 0.5 | 0.5 | 0.5 | 0.5 |
| | Glass transition temperature (° C.) | | −27 | −27 | −51 | −25 | −37 |
| | Weight average molecular weight (×10⁴) | | 57 | 57 | 59 | 55 | 51 |
| Cross-linking agent (parts by weight) | | | 3 | 3 | 3 | 3 | 3 |
| Tackifier | | Terpene phenol resin A | 10 | 10 | 10 | 10 | 10 |
| (parts by weight) | | Polymerized rosin ester resin B | 14 | 14 | 14 | 14 | 14 |
| | | Hydrogenated rosin ester resin C | 10 | 10 | 10 | 10 | 10 |
| Thickness of adhesive tape (μm) | | | 75 | 200 | 50 | 50 | 50 |
| Gel fraction of adhesive tape (% by weight) | | | 27 | 27 | 34 | 29 | 31 |
| Thickness of substrate (μm) (nylon 610) | | | 25 | — | — | — | — |
| Thickness of substrate (μm) | | | — | 100 | — | — | — |
| (foam substrate, expansion ratio 3 times) | | | | | | | |
| Evaluation | Bio-derived carbon | % by weight | 74 | 70 | 81 | 78 | 80 |
| | content | | | | | | |
| | Plane direction | MPa | 1.31 | Substrate | 1.02 | 1.28 | 1.14 |
| | peeling force | | | broke | | | |
| | Shear direction | MPa | 1.46 | Substrate | 0.91 | 1.32 | 1.54 |
| | peeling force | | | broke | | | |

| | | | Example | | |
|---|---|---|---|---|---|
| | | | 26 | 27 | 28 |
| (Meth)acrylic | Monomer A | Lauryl acrylate | 48 | — | 34 |
| copolymer | | Lauryl methacrylate | — | 48 | 34 |
| | | n-Decyl methacrylate | — | — | — |
| | | n-Octyl acrylate | — | — | — |
| | | n-Heptyl acrylate | — | — | — |
| | | Isobornyl acrylate | — | — | — |
| | Monomer B | Vinyl laurate | — | — | — |
| | | Vinyl caprate | — | — | — |
| | Bio-derived | Stearyl acrylate | — | — | — |
| | monomer | Isostearyl acrylate | 48 | 48 | 29 |
| | | 2-Decyl tetradecanyl | — | — | — |
| | | acrylate | | | |
| | Non-bio-derived | 2-Ethylhexyl acrylate | — | — | — |
| | monomer | Butyl acrylate | — | — | — |
| | | Ethyl acrylate | — | — | — |
| | | Methyl acrylate | — | — | — |
| | | Acrylic acid | 3 | 3 | 3 |
| | | Hydroxyethyl acrylate | 0.5 | 0.5 | 0.5 |
| | Glass transition temperature (° C.) | | −55 | −40 | −48 |
| | Weight average molecular weight (×10⁴) | | 58 | 52 | 54 |
| Cross-linking agent (parts by weight) | | | 3 | 3 | 3 |
| Tackifier | | Terpene phenol resin A | 10 | 10 | 10 |
| (parts by weight) | | Polymerized rosin ester resin B | 14 | 14 | 14 |
| | | Hydrogenated rosin ester resin C | 10 | 10 | 10 |
| Thickness of adhesive tape (μm) | | | 50 | 50 | 50 |
| Gel fraction of adhesive tape (% by weight) | | | 41 | 38 | 43 |
| Thickness of substrate (μm) (nylon 610) | | | — | — | — |
| Thickness of substrate (μm) | | | — | — | — |
| (foam substrate, expansion ratio 3 times) | | | | | |
| Evaluation | Bio-derived carbon | % by weight | 83 | 81 | 80 |
| | content | | | | |
| | Plane direction | MPa | 0.87 | 1.18 | 1.31 |
| | peeling force | | | | |
| | Shear direction | MPa | 0.95 | 1.42 | 1.45 |
| | peeling force | | | | |

TABLE 4

| | | | Comparative Example | | | | |
|---|---|---|---|---|---|---|---|
| | | | 1 | 2 | 3 | 4 | 5 |
| (Meth)acrylic | Monomer A | Lauryl acrylate | — | — | — | — | 29 |
| copolymer | | Lauryl methacrylate | — | — | — | — | — |
| | | n-Decyl methacrylate | — | — | — | — | — |
| | | n-Octyl acrylate | — | — | — | — | — |
| | | n-Heptyl acrylate | — | — | — | — | — |
| | | Isobornyl acrylate | — | — | — | 48 | — |
| | Monomer B | Vinyl laurate | — | — | — | — | — |
| | | Vinyl caprate | — | — | — | — | — |
| | Bio-derived | Stearyl acrylate | — | — | 97 | — | — |
| | monomer | Isostearyl acrylate | — | — | — | — | — |
| | | 2-Decyl tetradecanyl | — | — | — | — | — |
| | | acrylate | | | | | |
| | Non-bio-derived | 2-Ethylhexyl acrylate | 34 | — | — | — | 68 |
| | monomer | Butyl acrylate | 49 | 78 | — | 48 | — |
| | | Ethyl acrylate | — | 19 | — | — | — |
| | | Methyl acrylate | 15 | — | — | — | — |
| | | Acrylic acid | 3 | 3 | 3 | 3 | 3 |
| | | Hydroxyethyl acrylate | 0.1 | 0.1 | 0.5 | 0.5 | 0.5 |
| | Glass transition temperature (° C.) | | −58 | −54 | 21 | −6 | −56 |
| | Weight average molecular weight (×10⁴) | | 70 | 75 | 64 | 63 | 66 |
| Cross-linking agent (parts by weight) | | | 1 | 1 | 3 | 3 | 1 |
| Tackifier | | Terpene phenol resin A | 10 | 10 | 10 | 10 | 10 |
| (parts by weight) | | Polymerized rosin ester resin B | 14 | 14 | 14 | 14 | 14 |
| | | Hydrogenated rosin ester resin C | 10 | 10 | 10 | 10 | 10 |
| Thickness of adhesive tape (μm) | | | 50 | 50 | 50 | 50 | 50 |
| Gel fraction of adhesive tape (% by weight) | | | 37 | 41 | 23 | 36 | 40 |
| Thickness of substrate (μm) (nylon 610) | | | — | — | — | — | — |
| Thickness of substrate (μm) | | | — | — | — | — | — |
| (foam substrate, expansion ratio 3 times) | | | | | | | |
| Evaluation | Bio-derived carbon | % by weight | 24 | 25 | 85 | 53 | 41 |
| | content | | | | | | |
| | Plane direction | MPa | 0.76 | 0.81 | 0.58 | 0.52 | 0.66 |
| | peeling force | | | | | | |
| | Shear direction | MPa | 0.78 | 0.85 | 0.35 | 0.54 | 0.79 |
| | peeling force | | | | | | |

### INDUSTRIAL APPLICABILITY

The present invention can provide an adhesive capable of exhibiting excellent adhesive force while having a high bio-derived carbon content, an adhesive tape containing the adhesive, and a method for fixing an electronic device component or an in-vehicle component.

1. An adhesive comprising
a (meth)acrylic copolymer that contains 48% by weight or more of structural units derived from a monomer A of the following formula (1) containing bio-derived carbon and/or a monomer B of the following formula (2) containing bio-derived carbon, and that has a glass transition temperature of −20° C. or lower: 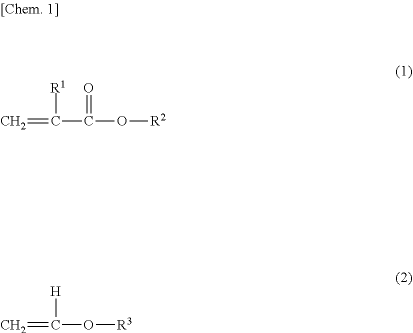
wherein
in the formula (1), R¹ is H or CH₃, R² is —CₙH₂ₙ₊₁, and n is an integer of 7 to 14;
in the formula (2), R³ is —C(═O)CₘH₂ₘ₊₁, and m is an integer of 7 to 13; and
the carbon in R² and R³ is bio-derived carbon.

2. The adhesive according to claim 1,
wherein the monomer A comprises at least one selected from the group consisting of n-octyl (meth)acrylate, lauryl (meth)acrylate, and decyl (meth)acrylate.

3. The adhesive according to claim 1,
wherein the monomer A comprises lauryl acrylate and/or lauryl methacrylate.

4. The adhesive according to claim 1,
wherein the monomer B comprises vinyl caprate and/or vinyl laurate.

5. The adhesive according to claim 1,
wherein the (meth)acrylic copolymer contains structural units derived from the monomer A, and
a structural unit derived from lauryl acrylate and/or lauryl methacrylate constitutes 48% by weight or more of the structural units derived from the monomer A.

6. The adhesive according to claim 1,
wherein the (meth)acrylic copolymer contains structural units derived from the monomer A,
a structural unit derived from lauryl acrylate constitutes 10 to 90% by weight of the structural units derived from the monomer A, and
a structural unit derived from lauryl methacrylate constitutes 10 to 90% by weight of the structural units derived from the monomer A.

7. The adhesive according to claim 1,
wherein the (meth)acrylic copolymer contains a structural unit derived from an alkyl (meth)acrylate having a C16-C24 alkyl group.

8. The adhesive according to claim 1, comprising 10 to 50 parts by weight of a bio-derived rosin tackifier and/or a bio-derived terpene tackifier relative to 100 parts by weight of the (meth)acrylic copolymer.

9. An adhesive tape comprising
an adhesive layer containing the adhesive according to claim 1.

10. The adhesive tape according to claim 9, further comprising a substrate,
wherein the substrate is a film containing a polyester or polyamide.

11. The adhesive tape according to claim 9, further comprising a foam substrate.

12. The adhesive tape according to claim 9, which is used for fixing an electronic device component or an in-vehicle component.

13. A method for fixing an electronic device component or an in-vehicle component using the adhesive tape according to claim 9.
